(19) United States
(12) Patent Application Publication
(10) Pub. No.: US 2024/0367917 A1
(43) Pub. Date: Nov. 7, 2024

(54) FEATURE RECOGNITION AND PROPER ORIENTATION IN ITEM PLACEMENT BY A ROBOT

(71) Applicant: Dexterity, Inc., Redwood City, CA (US)

(72) Inventors: Joseph Li, San Jose, CA (US); Robert Moreno, East Palo Alto, CA (US); Cuthbert Sun, San Francisco, CA (US); James Levin, Sparta, NJ (US); Yunju Chen, San Francisco, CA (US); Arth Beladiya, Santa Clara, CA (US)

(21) Appl. No.: 18/652,538

(22) Filed: May 1, 2024

Related U.S. Application Data
(60) Provisional application No. 63/463,368, filed on May 2, 2023.

(51) Int. Cl. B65G 47/244; B25J 9/16; B65G 47/91

(52) U.S. Cl. CPC B65G 47/244; B25J 9/1661; B25J 9/1697; B65G 47/917; B65G 2201/025; B65G 2203/0216; B65G 2203/0225; B65G 2203/044

(57) ABSTRACT

A robotic system configured to detect a target feature and place an item at an orientation determined based at least in part on the location of the target feature on the item is disclosed. In various embodiments, sensor data from a sensor in a workspace is received via a communication interface. The sensor data is used to determine the location of a target feature on an item. The determined location is used to generate and implement a plan to use a robotic arm to place the item at a destination location at an orientation determined based at least in part on the determined location of the target feature on the item.

### CROSS REFERENCE TO OTHER APPLICATIONS

This application claims priority to U.S. Provisional Patent Application No. 63/463,368 entitled FEATURE RECOGNITION AND PROPER ORIENTATION IN ITEM PLACEMENT BY A ROBOT filed May 2, 2023, which is incorporated herein by reference for all purposes.

### BACKGROUND OF THE INVENTION

Robots have been provided to handle products in boxes and other containers and/or packaging, in a variety of contexts, including without limitation sortation/singulation, palletization/de-palletization, truck or container loading/unloading, etc. In some contexts, there may be a requirement to ensure that a label, optical code, logo, sticker, symbol, primary or otherwise preferred box face, etc. be oriented in a certain prescribed way, such as to ensure that a bar code or other optical code can be read by a downstream scanner, or to ensure that product logos are facing forward for display in a retail setting, etc. For example, in palletization and de-palletization processes, there may be certain requirements that pertain to orienting an item in a prescribed orientation. Examples include, without limitation:
Depalletization: Cases when placed onto a conveyor belt must have barcodes oriented in the same direction as a downstream barcode scanner (e.g., on the right or left side of conveyor belt).
Palletization: Some customers have quality requirements such as orienting the barcode of each case on the pallet facing outwards, so that barcodes can be easily scanned.
Palletization: Some retail customers, such as warehouse stores, may require “store ready” pallets, with boxes all having a logo/label facing in a same certain orientation on the pallet.

In typical prior approaches, palletization or de-palletization, or other operations to requiring specific item orientation at placement, would need to be done manually to ensure proper orientation, or if a customer were to use robotics, customers could be constrained to using robotics for single SKU palletization or depalletization, where the orientation of boxes are homogenous and known.

### BRIEF DESCRIPTION OF THE DRA WINGS

Various embodiments of the invention are disclosed in the following detailed description and the accompanying drawings.

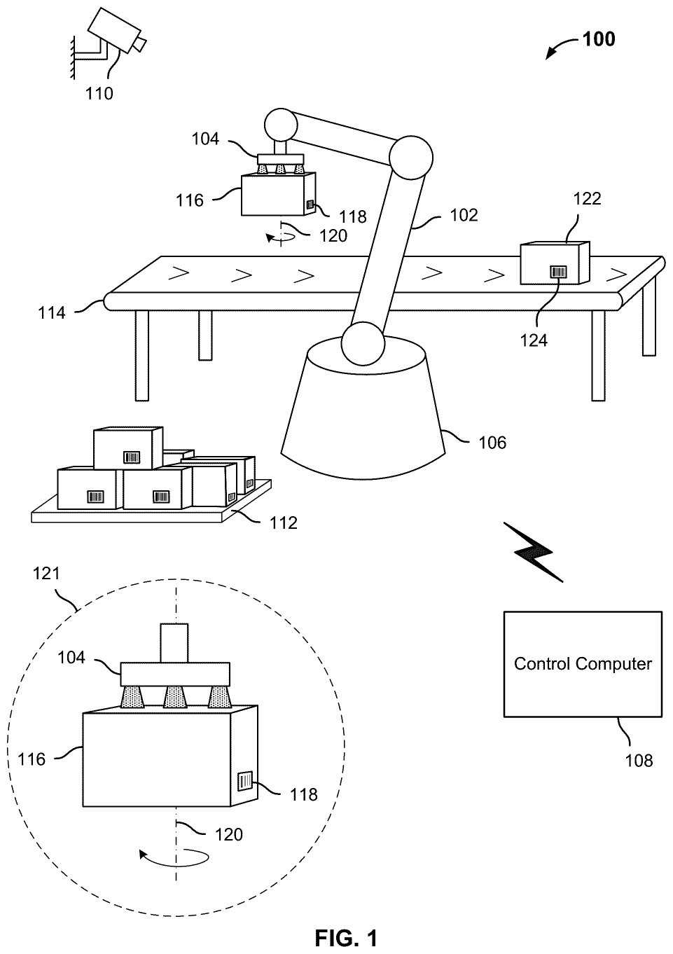

FIG. 1 is a block diagram illustrating an embodiment of a robotic system configured to detect an item feature and place the item in an associated orientation.

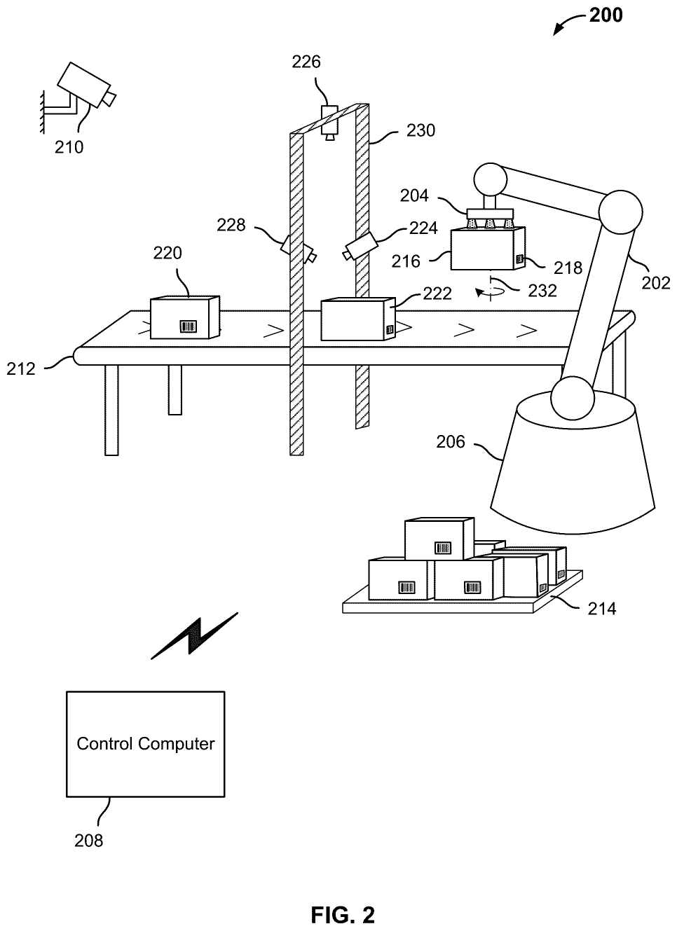

FIG. 2 is a block diagram illustrating an embodiment of a robotic system configured to detect an item feature and place the item in an associated orientation.

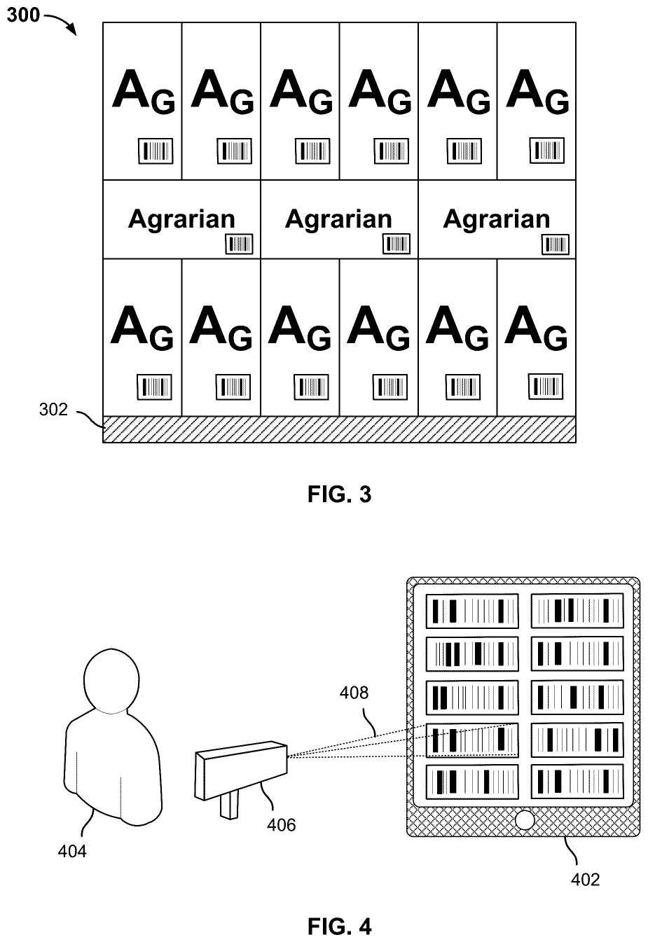

FIG. 3 is a diagram illustrating an example of boxes stacked on a pallet, each in a prescribed orientation, in an embodiment of a robotic system configured to detect an item feature and place the item in an associated orientation.

FIG. 4 is a diagram illustrating an embodiment of a scannable user interface associated with a robotic system configured to detect and capture an image of an item feature.

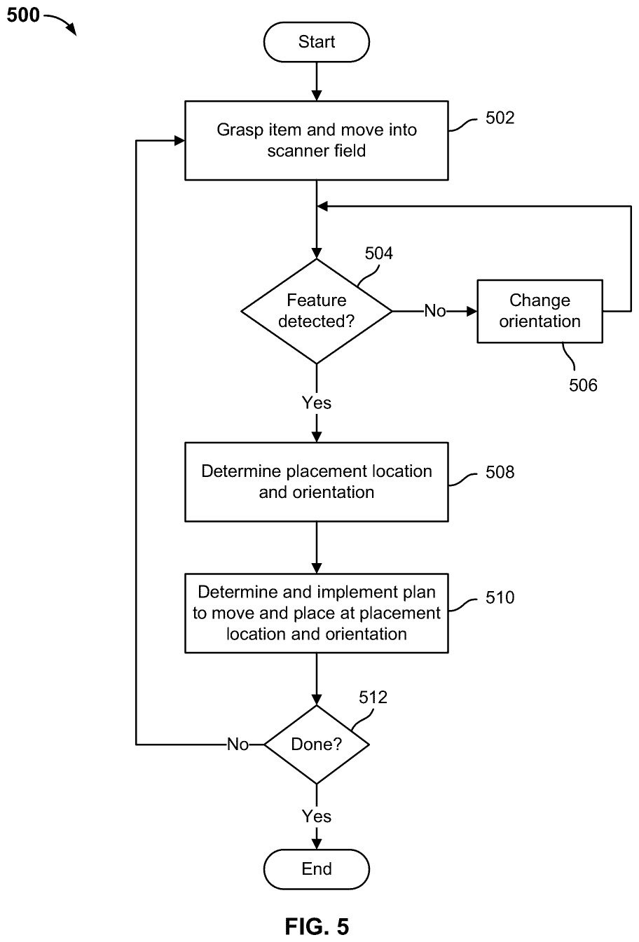

FIG. 5 is a flow diagram illustrating an embodiment of a process to detect an item feature and place the item in an associated orientation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic system is disclosed that detects, automatically, a target feature of an item and places the item in an orientation such that the detected feature faces a desired direction. The feature may comprise one or more of a label, an optical or other scannable code, text, one or more images, one or more colors, a visual pattern, a texture, etc. The feature may be detected using computer vision. For example, one or more images may be processed to determine if the feature is included in an image. If the feature is detected in an image, the location and orientation of the feature is determined and tracked. The item is placed to cause the feature to be exposed (or not) as prescribed. If the feature is not, at first, detected, the item may be moved to another position and/or orientation, and/or continuously and/or iteratively to successive positions and/or orientations, until the feature is detected.

In various embodiments, computer perception and vision algorithms are used to recognize arbitrary features (barcodes, logos, symbols, etc.) on a box or other item that a robotic arm has been used to grasp (or is about to grasp). The robotic arm is used to place the box or other item in an orientation such that the detected feature faces a desired direction. Examples include, without limitation, ensuring that for each box or other item a shipping (or other label), a barcode or other optical code, a logo, etc. faces in a prescribed direction. For example, for items placed on an output conveyor, each item may be placed such that its bar code faces in a direction that facilitates scanning by a downstream scanner. For example, in a fixed or handheld scanner may be used to scan packages from a right side of the conveyor, each box/item may be placed on the conveyor such that its barcode faces right.

In various embodiments, the detected feature (not limited to but including barcodes, logos, symbols) can be displayed directly on a user interface, in addition to the robot physically orienting the box accordingly. Display in the user interface may enable an operator to manually scan the bar code or other feature from the user interface.

In some embodiments, the system may be configured and/or trained to detect the target feature. For example, images of a logo, label, barcode, etc. may be uploaded and the system may process image data to detect matching or partially matching images. In some embodiments, human supervised machine learning may be used to train the system to detect a target feature and/or to improve accuracy of detection.

In various embodiments, techniques disclosed herein enable robots to meet certain requirements for use cases including but not limited to:
Depalletization: Cases when placed onto a conveyor belt must have barcodes oriented in the same direction as the barcode scanner (e.g., right or left side of conveyor belt).
Palletization: Some customers have quality requirements such as orienting the barcode of each case on the pallet facing outwards, so that barcodes can be easily scanned as a pallet is received.
Palletization: Some retail customers, such as warehouse stores, need “store ready” pallets. For example, every box or other item on a pallet has a prescribed logo/label facing in a certain orientation on the pallet, e.g., facing forward, so consumers see the same feature on all boxes as they view the palletized boxes from the front.

In various embodiments, a robotic system as disclosed herein retrieves boxes or other items serially. Each item is moved first to or through a field of view of a set of cameras and/or other sensors. Sensor data (e.g., image data) is used to detect the prescribed feature. The system determines how to orient/reorient the box/item for placement such that the detected feature faces in the prescribed direction, rotates the item to the prescribed orientation (if needed) and moves the item to its destination and places it in the prescribed orientation.

In various embodiments, images generated to detect a target feature, such as a barcode, to be able to place the item with the detected feature oriented in a prescribed way may also be used to capture an image of the feature, e.g., a barcode, in a user interface. A human or other operator can then manually scan the barcode from the user interface, eliminating the need in some contexts to update data systems to handle or display information for a new item, such as a new product or SKU.

FIG. 1 is a block diagram illustrating an embodiment of a robotic system configured to detect an item feature and place the item in an associated orientation. In the example shown, robotic system and environment 100 includes a robotic arm 102 equipped with a suction-based end effector 104. Robotic arm 102 in this example is mounted on a fixed base 106. In other embodiments, robotic arm 102 may be mounted on a mobile basis, such as an autonomously or otherwise robotically controlled mobile chassis. Robotic arm 102 and end effector 104 are controlled by a control computer 108. Control computer 108 receives image data from one or more cameras and/or scanners, represented in FIG. 1 by camera/scanner 110.

Control computer 108 sends commands to robotic arm 102 and/or end effector 104 to perform a set of tasks associated with a higher-level operation or objective. In the example shown, the higher-level task is to remove boxes from pallet 112 and place them singly on conveyor 114 at a prescribed orientation. For example, the prescribed orientation may be an orientation that results in a optically scannable code or other visible feature facing in a certain direction for scanning/image capture.

In the state shown in FIG. 1, robotic arm 102 and end effector 104 have been used to grasp box 116 having a bar code 118 on one side panel, as shown. In various embodiments, control computer 108 receives image data from 110 and determines for a given box in the grasp of robotic arm 102 and end effector 104 at the orientation then observed—e.g., box 116 in the example shown-whether a prescribed target image is visible, e.g., bar code 118 in the example shown. If not, control computer 108 moves the item (e.g., box 116) through a sequence of orientations, or continuously in some prescribed manner, until the target image is visible, in this example bar code 118. For example, as shown, the robotic arm 102 and/or end effector 104 may be used to rotate box 116 about a vertical (z) axis 120, until the bar code 118 is detected in one or more images captured by camera (or scanner) 110. (The elements 104, 116, 118, and 120 are reproduced in larger scale in circle 121, for clarity.)

In some embodiments, if the target image is not found by rotating a box about the vertical axis, robotic arm 102 may be used to tilt the box (e.g., 116) so as to expose the side opposite the end effector 104 to the camera 110. In some embodiments, e.g., a box that is too heavy to expose the surface opposite the end effector 104 to camera 110, the box may be placed down, e.g., in a buffer or work zone, and robotic arm 102 and/or end effector 104 may be used to carefully tip the box onto a different side, enabling the box to be re-grasped from the top in a different orientation than before, allowing other surfaces to be checked for the target image.

In some embodiments, an image of the top surface of a box may be checked prior to grasping, and if the target image is on the top the end effector may be used to grasp the box from the side, so the box can be placed with the image facing in the prescribed direction.

In some embodiments, if the target image cannot be found, the control computer 108 prompts a human worker to intervene. The box may be placed in a buffer or work zone accessible by the human worker, who may change the orientation of the box to better expose the target image to the view of robotic system 100, e.g., within a field of view of camera 110.

Once the target image is detected, the orientation of the box at the time the image was generated and the location (and orientation) of the target image are used to determine a side on which the target image is located. Control computer 108 uses the determined information to move and place the box at a placement location on the conveyor in the prescribed orientation. For example, as shown in FIG. 1, a box may be placed in an orientation such that the target image (e.g., bar code) faces a prescribed direction, e.g., to facilitate reading of the bar code by a scanner located downstream of robotic arm 102. In the example shown, box 122 has been placed with bar code 124 facing forward, towards the side on which robotic arm 102 is located.

FIG. 2 is a block diagram illustrating an embodiment of a robotic system configured to detect an item feature and place the item in an associated orientation. In the example shown, robotic system and environment 200 includes robotic arm 202 equipped with a suction-based end effector 204. Robotic arm 202 in this example is mounted on a fixed base 206. Robotic arm 202 and end effector 204 are operated under the control of control computer 208, which uses images generated by camera/scanner 210.

While in FIG. 1 robotic arm 102 and end effector 104 were being used to pick boxes from pallet 112 and place them singly each at a prescribed orientation on conveyor 114, in FIG. 2 robotic arm 202 and end effector 204 are being used to pick boxes (or other items) arriving at arbitrary orientations via conveyor 212 and place them on pallet 214, each in an orientation such that a prescribed optical code or other image or visible or otherwise scannable feature faces in a prescribed direction, e.g., outwardly.

While the examples shown in FIGS. 1 and 2 illustrate, respectively, taking items from a pallet and placing them singly on a conveyor or picking them from a conveyor and stacking them on a pallet, techniques disclosed herein may be used in any context in which an item in an arbitrary initial orientation is picked and placed in an orientation determined at least in part on where an optical code, label, image, or other visible or otherwise scannable feature is determined to be located.

Referring further to FIG. 2, in the example and state shown, robotic arm 202 and end effector 204 have been used to grasp box 216 having bar code 218 on a side as shown. Boxes 220 and 222 are shown arriving next via conveyor 212, each in an arbitrary orientation resulting in their respective bar codes facing different directions. As the boxes 218, 220, 222 are advanced by conveyor 212, each passes through an array of cameras/scanners 224, 226, 228 mounted on a frame 230. In various embodiments, images and/or other output generate by one or more of cameras/scanners 224, 226, 228 and/or camera/scanner 210 may be used, e.g. by control computer 208, to determine a location and orientation of a target image (e.g., bar code 218 on box 216.

As it is grasped, each box is then moved to a destination location and placed there at a prescribed orientation. For example, box 216 is shown being rotated about vertical axis 232 to place bar code 218 at a desired orientation when box 216 is placed on pallet 214. In this example, the boxes on pallet 214 are oriented such that for each its bar code faces out, as may be desired to enable a human or other robotic worker to scan the bar codes.

FIG. 3 is a diagram illustrating an example of boxes stacked on a pallet, each in a prescribed orientation, in an embodiment of a robotic system configured to detect an item feature and place the item in an associated orientation. In the example shown, boxes 300 have been stacked on a pallet 302, each in a prescribed orientation resulting in high stability while exposing both a machine/device readable bar code and a human readable product and/or brand name or logo being visible to one view the boxes 300 from the front. In this case, each box has been placed so that either the fictitious name “Agrarian” or logo comprising a stylized arrangement of the capital letters “A” and “G” are visible.

In some embodiments, a robotic system as disclosed herein is used to create an “aisle ready” pallet such the one shown in FIG. 3. For example, a control computer may determine algorithmically a plan to create a stable pallet in which each box has one or the other of a set of two or more preferred orientations, combining considerations of stability with the requirement to have one of the prescribed faces facing forward, as in the example shown in FIG. 3.

FIG. 4 is a diagram illustrating an embodiment of a scannable user interface associated with a robotic system configured to detect and capture an image of an item feature. In various embodiments, a robotic system as disclosed herein, e.g., robotic system 100 of FIG. 1 or robotic system 200 of FIG. 2, captures and parses images generated by cameras/scanners comprising the system to extract for each box (or other item) an image of its bar code (or other optical code). In various embodiments, the robotic system uses the images to display an array of captured images of optical codes of items that have been handled or otherwise processed by the system. As shown in FIG. 4, the array of captured images of optical codes may be displayed in a display device comprising a fixed, mounted, or mobile device, such as device 402. A human user 404 may then use a hand-held or other scanner 406 to scan 408 individual bar codes as displayed on the device 402.

While in the example shown in FIG. 4 a scanner 406 that uses reflected light 408 to scan bar codes displayed on the device 402, in other embodiments a passive code reader, e.g., a mobile device with a camera and an app to decode bar codes or other optical codes, may be used.

In various embodiments, a user interface and handheld or other scanner, as shown in FIG. 4, may be used to verify the inventory of items that have been handled by the robotic system, to add new SKU's to a product database, etc.

While in the example discussed above the bar code images are captured in connection with detecting a target image and placing an item in an orientation determined based at least in part on the determined location of the target image on the item, in some embodiments a user interface and interaction as shown in FIG. 4 may be used in a system that does not (necessarily) use images captured for another purpose, such as to place items at a prescribed orientation.

In various embodiments, a system as disclosed herein is configured to apply a label to a box or other item, e.g., in a prescribed location, at a prescribed orientation, and/or in a manner that does to obscure or otherwise interfere with the reading of any other label or printed information. For example, some palletizing and depalletizing applications require placing a label on the cases. Some customers require specific region of interest placements of these labels on the cases that vary customer by customer.

In various embodiments, a robotic system as disclosed herein detects existing features and/or labels on the cases (eg. SKU barcodes, QR codes, features on boxes) and avoids placing the new label on top of these labels or, alternatively, a customer may want the robot to place the new label on top of existing labels so that the box only has one exposed barcode. In various embodiments, techniques disclosed herein, e.g., a combination of barcode detection, machine learning, and instance segmentation, may be used in various embodiments, to detect existing barcodes, labels, features on the box when determining dynamically to place the label on the box or other item, e.g., either to avoid covering or intentionally to cover the preexisting bar code or other label.

FIG. 5 is a flow diagram illustrating an embodiment of a process to detect an item feature and place the item in an associated orientation. In various embodiments, the process 500 of FIG. 5 may be performed by a control computer comprising a robotic system as disclosed herein, e.g., control computer 108 of FIG. 1 or control computer 208 of FIG. 2.

In the example shown, at 502, an item is grasped and moved into a field of view of a scanner (e.g., camera). If the target feature is NOT detected in the image(s) generated by the scanner/camera, at 504, then at 506 the orientation of the item is changed unless/until the target feature is detected. Once the target feature is detected (504), then at 508 a placement location and orientation is determined for the item, based at least in part on where the target feature is determined to be located on the item, and at 510 a place to move and place the item at the determined placement location and orientation is determined and implemented. Successive iterations of the process 500 are performed until it is determined at 512 that no further items remain to be processed.

In some embodiments, a robotic system as disclosed herein is configured to use machine learning to determine how and/or how best to find a target feature on an item of a given type and/or having given attributes. For example, a system as disclosed herein may learn to recognize an image that has been observed to appear consistently on a side adjacent to a side having the target feature. In such a case, the system may learn that the feature can be found most efficiently by rotating the box or other item in a particular direction, e.g., the adjacent side having the target feature is exposed to the camera/scanner next, without having to rotate through sides that do not have the target feature.

While embodiments that include cameras/scanners mounted in a workspace and/or on fixed structures in a workspace have been described, in various embodiments one or more movable cameras/scanners may be used in place of and/or in addition to fixed cameras/scanners. For example, a camera mounted on a robotic arm and/or end effector may be used, such as to look down onto a top surface of any item prior to grasping the item.

In various embodiments, techniques disclosed herein may be used in a robotic system to automatically detect, in each item handled, a target feature, and to place the item in an orientation such that the target feature is oriented in a prescribed manner, such as to ensure the barcode on each item faces a downstream scanner or faces outward (or upward) to facilitate scanning by fixed or handheld scanners.

While in some examples the detected target feature is a barcode or other optical code, in other embodiments other features may be detected and used to orient the item, such as a warning label, arbitrary text, images, detected damage, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a communication interface configured to receive sensor data from a sensor in a workspace; and
a processor coupled to the communication interface and configured to:
use the sensor data to determine a location of a target feature on an item; and
use the determined location to generate and implement a plan to place the item at a destination location at an orientation determined based at least in part on the determined location of the target feature on the item.

2. The robotic system of claim 1, further comprising a robotic arm equipped with an end effector, wherein the processor is configured to control one or both of the robotic arm and the end effector to grasp the item, move the item to the destination location, and place the item at the destination location in the orientation determined based at least in part on the determined location of the target feature on the item.

3. The robotic system of claim 1, wherein the target feature comprises an optical code.

4. The robotic system of claim 3, wherein the optical code comprises a bar code and the sensor comprises a bar code scanner.

5. The robotic system of claim 1, wherein the sensor comprises a camera and the sensor data comprises image data.

6. The robotic system of claim 5, wherein the processor is further configured to extract from the image data an image of the target feature.

7. The robotic system of claim 6, wherein the processor is further configured to cause the image of the target feature to be displayed on a display device.

8. The robotic system of claim 7, wherein the processor is configured to cause the image of the target feature to be displayed on a display device via a user interface in which a plurality of images, each associated with a respective target feature of a corresponding item, are displayed.

9. The robotic system of claim 1, wherein the processor is configured to determine, based on the sensor data, that the target feature has not yet been detected and to change an orientation of the item within a field of view of the sensor.

10. The robotic system of claim 9, wherein the processor is configured to change the orientation of the item within the field of view of the sensor at least in part by rotating the item about an axis associated with one or both of the item and the end effector.

11. The robotic system of claim 10, wherein the axis comprises a vertical or other “z” axis.

12. The robotic system of claim 9, wherein the processor is configured to change the orientation of the item within the field of view of the sensor at least in part by placing the item in a buffer location, reorienting the item while placed in the buffer location, regrasping the item as reoriented in the buffer location, and moving the item back into the field of view of the sensor.

13. The robotic system of claim 1, wherein the end effector comprises a suction type end effector.

14. The robotic system of claim 13, wherein the processor is configured to use the end effector to grasp the item from the top.

15. The robotic system of claim 1, wherein the processor is configured to determine that the target feature has not been detected at any available orientation.

16. The robotic system of claim 15, wherein the processor is configured to invoke assistance from a human worker based at least in part on the determination that the target feature has not been detected at any available orientation.

17. The robotic system of claim 1, wherein the sensor is mounted in a fixed location.

18. The robotic system of claim 1, wherein the sensor is mounted on one or more of a robotic arm, an end effector, or another movable element comprising the robotic system.

19. A method, comprising:
receiving via a communication interface sensor data from a sensor in a workspace;
using the sensor data to determine a location of a target feature on an item; and
use the determined location to generate and implement a plan to use a robotic arm to place the item at a destination location at an orientation determined based at least in part on the determined location of the target feature on the item.

20. A computer program product embodied in a non-transitory computer readable medium and comprising computer instructions for:
receiving via a communication interface sensor data from a sensor in a workspace;
using the sensor data to determine a location of a target feature on an item; and
use the determined location to generate and implement a plan to use a robotic arm to place the item at a destination location at an orientation determined based at least in part on the determined location of the target feature on the item.
